(19) United States
(12) Patent Application Publication
(10) Pub. No.: US 2010/0268921 A1
(43) Pub. Date: Oct. 21, 2010

(54) DATA COLLECTION PREFETCH DEVICE AND METHODS THEREOF

(75) Inventor: Adam C. Preble, Austin, TX (US)

Correspondence Address: LARSON NEWMAN & ABEL, LLP, 5914 WEST COURTYARD DRIVE, SUITE 200, AUSTIN, TX, 78730, US

(73) Assignee: ADVANCED MICRO DEVICES, INC., Sunnyvale, CA (US)

(21) Appl. No.: 12/423,912

(22) Filed: Apr. 15, 2009

(51) Int. Cl. G06F 9/315

(52) U.S. Cl. 712/225; 712/E09.034

(57) ABSTRACT

A method of retrieving information from a memory includes receiving an instruction associated with a data collection. In response to determining the instruction is a request to retrieve a first element of the data collection, an application program interface (API) generates an instruction to prefetch a second element of the data collection. In one embodiment, the second element to be prefetched is indicated by a pointer or other information associated with the first element. In response to the prefetch instruction, an execution core of the data processing device retrieves the second element from a memory module and stores the second element at a cache. By prefetching the second element before it has been explicitly requested by the application, the efficiency of the application can be increased.

### FIELD OF THE DISCLOSURE

The present disclosure relates to data processing devices, and more particularly to retrieving information from a memory at a data processing device.

### BACKGROUND

Application programs executing at a data processing device typically manipulate information stored in a memory. Some devices employ a main memory and a cache, whereby the cache can be accessed more efficiently than the main memory, but stores less information. Accordingly, the data processing device can copy information stored at the main memory to the cache, in order to allow the application programs to access the copied information more efficiently. Further, some data processing devices employ a hardware prefetch device to improve memory efficiency. The hardware prefetch device typically predicts information that an application program is likely to access in the relatively near future, and copies the information from the main memory to the cache before the information is explicitly requested by the application. However, such hardware prefetch devices may not accurately predict the information that is likely to be accessed. In addition, an application programmer can place explicit prefetch instructions in an application program to instruct the program to prefetch designated information in advance of the program using the information. However, this can result in undesirably large and inefficient application programs

### BRIEF DESCRIPTION OF THE DRAWINGS

The present disclosure may be better understood, and its numerous features and advantages made apparent to those skilled in the art by referencing the accompanying drawings.

FIG. 1 is a block diagram of a data processing device in accordance with one embodiment of the present disclosure.

FIG. 2 is a diagram illustrating a particular embodiment of information stored the memory module of FIG. 1.

FIG. 3 is a diagram illustrating an alternative embodiment of information stored the memory module of FIG. 1.

FIG. 4 is a flow diagram illustrating a method of accessing a data collection in accordance with one embodiment of the present disclosure.

### DETAILED DESCRIPTION

A method of retrieving information from a memory includes receiving an instruction associated with a data collection. In response to determining the instruction is a request to retrieve a first element of the data collection, an application program interface (API) generates an instruction to prefetch a second element of the data collection. In one embodiment, the second element to be prefetched is indicated by a pointer or other information associated with the first element. In response to the prefetch instruction, an execution core of the data processing device retrieves the second element from a memory module and stores the second element at a cache. By prefetching the second element before it has been explicitly requested by the application, the efficiency of the application can be increased.

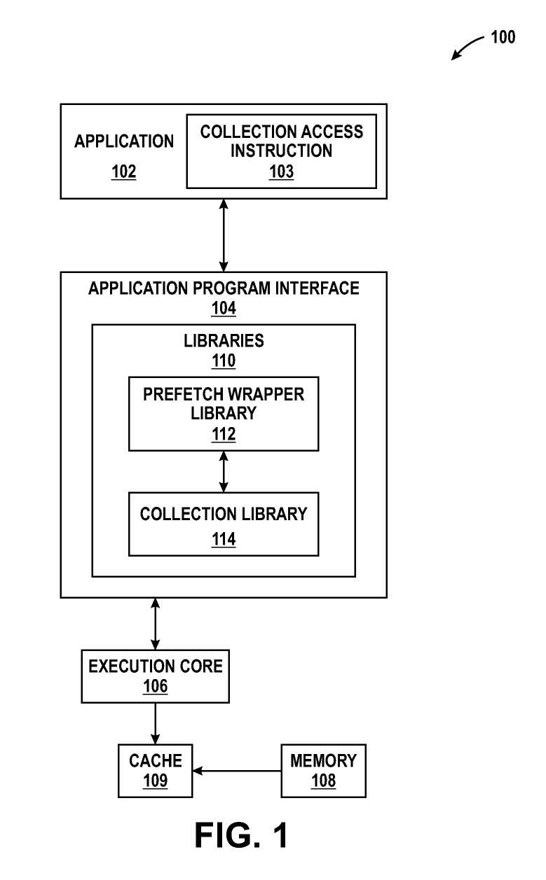

Referring to FIG. 1, a data processing device 100 in accordance with one embodiment of the present disclosure is illustrated. The data processing device 100 includes an execution core 106 connected to a cache 109, which is in turn connected to a memory 108. The execution core 106 includes hardware configured to execute instructions in order to perform designated tasks. For example, in response to particular instructions, the execution core can load data from the memory 108 or the cache 109 into one or more internal registers, perform arithmetic operations on the loaded data, and store the resultant data to the memory 108 or the cache 109. For purposes of discussion, the instructions executed by the execution core 106 are referred to as “core instructions.” As used herein, a core instruction refers to an instruction that is part of the instruction set associated with an execution core.

The memory 108 is a computer readable medium such as a memory module configured to respond to instructions from the execution core 106 to store information. For example, in response to a load instruction received from the execution core 106, the memory 108 retrieves information stored at the memory address indicated by the load instruction. In response to a store instruction, the memory 108 stores the information indicated by the instruction to a memory address indicated by the instruction. In the illustrated embodiment, the memory 108 receives instructions via the cache 109. In this configuration, the cache 109 is assumed to include a memory controller (not shown) which determines whether information to be loaded to the execution core 106 is to be retrieved from the cache 109 are is to first be loaded from the memory 108 to the cache 109.

The cache 109 is a computer readable medium configured to respond to instructions from the execution core 106 to store information, in similar fashion to the memory 108. In an embodiment, the cache 109 can respond to received instructions to store or load information more quickly than the memory 108, but can store a relatively smaller amount of information.

In operation, the execution core 106 is configured to execute an application 102 in conjunction with an application program interface (API) 104. The application 102 is an application program including a set of instructions configured to perform specified tasks associated with the application 102. For purposes of discussion, the instructions employed by the application 102 are referred to as “application instructions.” Application instructions typically cannot be executed directly by the execution core 106. Instead, the application instructions are translated by the API 104 into sets of core instructions suitable for execution by the execution core 106.

The API 104 includes resources that can be accessed by the application 102 in order to use the execution core 106 to perform designated tasks. In particular, the API 104 can translate application instructions provided by the application 102 to core instructions in order to perform tasks indicated by the application instructions. As used herein, translation can include automatically generating core instructions based on a received application instruction in order to perform one or more tasks indicated by the application instruction. Translation can also include other functions, such as determination of memory addresses, data formats, and other information in order to execute the application instruction. This can be better understood with reference to an example. In this example, the API 104 receives an application instruction requesting to retrieve data, designated by the application instruction as RECORD1. In response, the API 104 can determine a memory address for RECORD1 and generate a LOAD instruction for the memory address. The LOAD instruction is a core instruction. Accordingly, the API 104 provides the LOAD instruction and address to the execution core 106, which retrieves the data associated with the address from the cache 109 or the memory 108 so that the data is accessible to the application 102.

Thus, the API 104 provides an interface between the application 102 and the execution core 106. This allows the relatively low-level classes of the API 104 and the execution core 106 to be abstracted from the application 102, providing for simpler design of the application. Thus, for example, the application 102 does not have to be designed adapted to a particular memory mapping scheme, data storage format, or other particular implementation of data processing device hardware.

The API 104 includes a number of resources to translate application instructions to core instructions. For example, the API 104 includes libraries 110. The libraries 110 represent standardized classes that can be accessed by the application 102 via defined application instructions. Thus, in response to receiving an application instruction, the API 104 accesses the library indicated by the application instruction. Each library can include one or more classes, which generate one or more core instructions based on the class in order to perform a task indicated by a received application instruction. Thus, for example, an input/output (I/O) library can include a number of classes associated with I/O operations, such as communication of information to a peripheral device. A data structure library can include a number of classes associated with operations related to data structures, such as classes to create a data structure instance, classes to add or modify elements of a data structure, and the like. In response to receiving a defined I/O application instruction, the API 104 can access the class at the I/O library and use the class to generate the appropriate core instructions to execute the task indicated by the application instruction.

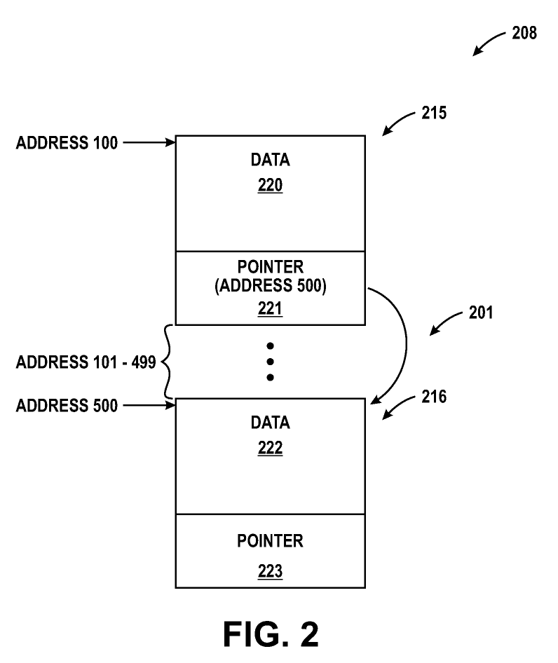

Referring again to application 102, the application can, via one or more application instructions, store information at memory 108 as a data collection. As used herein, a data collection refers to a set of information including a number of related data elements associated by the application into the collection. Examples of data collections include linked lists, doubly linked lists, trees, vectors, hash tables, and the like. Data collections are stored at the memory 108 so that an element of the collection can indicate the memory location of another collection element. This can be better understood with reference to FIG. 2.

FIG. 2 illustrates a data collection 201 stored at the memory 208. For purposes of discussion, each unit of collection information is referred to as a “record.” In the illustrated embodiment, the data collection 201 includes record 215 and record 216. Each record includes a unit of data, referred to as an element, of the collection and also includes pointer information indicative of a memory location of another element of the collection. Thus, record 215 includes element 220 and pointer information 221, while record 216 includes element 222 and pointer information 223.

The pointer information of each record can indicate the location of another record at the memory 208. In the illustrated embodiment, the pointer information 221 of record 215 indicates the memory address (labeled “ADDRESS 500”) of the record 226. In other embodiments, the pointer information may not indicate a particular address, but may indicate other location information, such as an offset from a defined base address. Because each record can include location information of other elements of the collection, data collection 201 can be flexibly stored at the memory 208. For example, in the illustrated embodiment, the records 215 and 226 are located at non-contiguous portions of the memory 208. As used herein, records are stored at non-contiguous portions of a memory when a set of records cannot be accessed at the memory sequentially. In another embodiment, the records of a collection can be stored according to an irregular pattern. For example, the records of the collection can be stored so that the number of memory locations between a first record and a second record is different than the number of memory locations between the second record and a third record.

Returning to FIG. 1, the libraries 110 includes a collection library 114 to facilitate creation and manipulation of collections. For example, the collection library can include classes to allow the addition of a record to a designated collection, classes to allow changes to the data elements of a collection, classes to access (e.g. retrieve) elements of a collection, and the like. The collection library 114 thus provides a flexible interface for the manipulation of collections based on application instructions provided by the application 102. In an embodiment, the collection library 114 is a portion of a larger data structure library (not shown).

The libraries 110 also include a prefetch wrapper library 112. As used herein, a wrapper library refers to a library whose classes provide an interface to another library. The classes of a wrapper library can also provide additional instructions to the library. Thus, for example, the prefetch wrapper library 112 can provide an interface to the collection library 114 for application instructions received from the application 102 and also, depending on the received instruction, provide additional instructions to be processed by the collection library 114.

In particular, in response to a receiving a collection access instruction 103, representing a request to access a particular record of a collection, the prefetch wrapper library 112 provides the instruction to the collection library 114, which in turn generates core instructions to access the requested data element. In addition, in response to the access instruction 103, the prefetch wrapper library automatically provides a request to the collection library 114 to retrieve the record associated with the pointer information of the requested record to ensure both records are located at the cache 109. This can be better understood with reference to FIG. 2.

In this example, it is assumed that the collection access instruction 103 represents an application instruction to access the data element 220 of record 215. Accordingly, in response to receiving the collection access instruction 103, the prefetch wrapper library provides the instruction to the collection library 114. In response, the collection library 114 generates core instructions to retrieve data element 220 and provides the core instructions to the execution core 106. In response to the core instructions, the execution core 106 determines if the record 215 is stored at the cache 109. If not, the execution core 106 retrieves the record 215 from the memory 108 and stores the retrieved record at the cache 109. If the record 215 is stored at the cache 109 when the core instructions are received, or after it has been retrieved from the memory 108, the execution core 109 provides the data element 220 to the API 104, which in turn returns the data element 220 to the application 102.

In addition, in response to receiving the collection access instruction 103, the prefetch wrapper library 112 provides an instruction to the collection library 114 to retrieve the record associated with the pointer information of the record 215. In response, the collection library 114 generates core instructions to retrieve the record and provides the instructions to the execution core 106. In response to the core instructions, the execution core 106 accesses the pointer information 221 and determines that it references memory address ADDRESS500. Accordingly, the execution core 106 determines if the record associated with ADDRESS500 (record 216) is located at the cache 109. If not, the execution core 106 retrieves record 216 from the memory 108 and stores it at the cache 109.

Thus, in response to a request to access a designated record, the API 104 automatically prefetches to the cache 109 additional records as indicated by the pointer information associated with the designated record. This can provide for more efficient operation of the application 102. For example, because the cache 109 can be accessed more efficiently than the memory 108, prefetching of collection records can provide for more efficient operation when the application 102 frequently accesses groups of records in the collection.

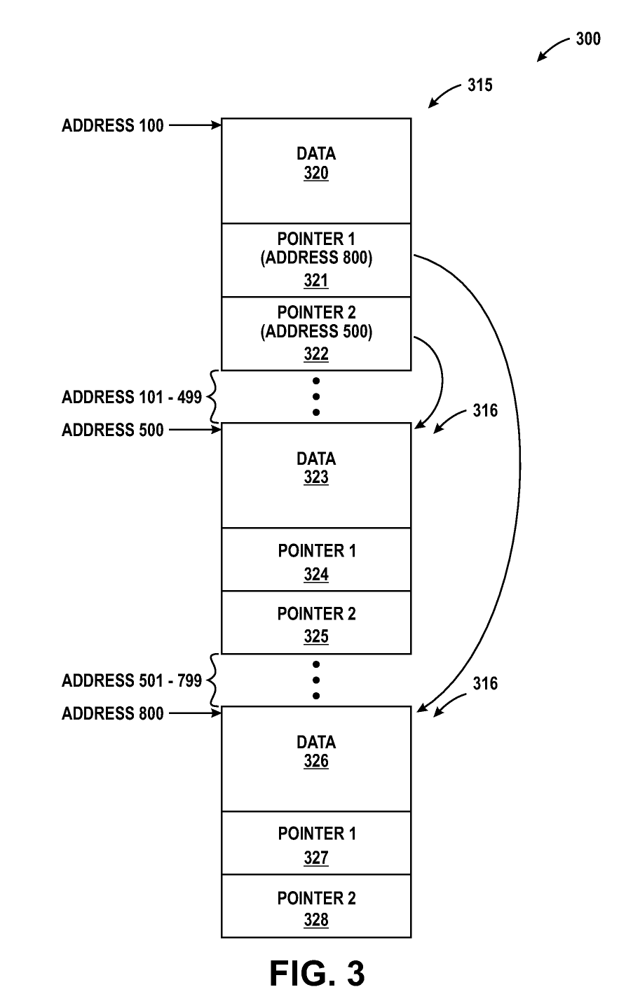

In an embodiment, the API 104 can prefetch multiple records in response to an access instruction. This can be understood with reference to FIG. 3, which illustrates records of a data collection 300 stored at the memory 108. The data collection 300 includes records 315, 316, and 317, each of which includes a data element and pointer information, whereby the pointer information indicates the location of up to two additional records. The data collection 300 is therefore structured as a doubly-linked list. Thus, in the illustrated embodiment, record 315 includes data element 320, pointer information 321, and pointer information 322, record 316 includes data element 323, pointer information 324, and pointer information 325, and record 317 includes data element 326, pointer information 327, and pointer information 328.

In the illustrated example of FIG. 3, the pointer information 321 of record 315 indicates the memory location of record 316, while the pointer information 322 of record 315 indicates the memory location of record 317. Accordingly, referring again to FIG. 1, in response to a collection access instruction requesting data element 315, the API 104 will provide prefetch instructions to the execution core 106 to prefetch the records 316 and 317 to ensure these records are stored in the cache 109. In particular, in response to the prefetch instructions, the execution core 106 accesses the pointer information 321 and the pointer information 322, and determines if the records associated with this information (i.e. records 316 and 317, respectively) is located at cache 109. If not, the execution core 106 retrieves records 316 and 317 from the memory 108 and stores the records at the cache 109.

Thus, according to example of FIG. 3, the API 104 can prefetch multiple records of an instruction in response to a request to access a designated record, thereby improving the efficiency of the application 102. Further, in a particular embodiment the records 315, 316, and 317 can be stored in an irregular fashion, such that there relative locations in memory can vary. Thus, in the illustrated example of FIG. 3 the number of memory locations between record 315 and record 316 is different than the number of memory locations between record 316 and 317. In addition, the relative number of memory locations between two records can change over time, as the records are moved to different memory locations by the application 102, an operating system (OS) or other module. The irregularity of the storage arrangement of the records makes it difficult for a hardware prefetcher located at execution core 106 to efficiently prefetch records of a collection. Accordingly, the generation of prefetches at the API 104 can improve the efficiency of devices having such hardware prefetchers.

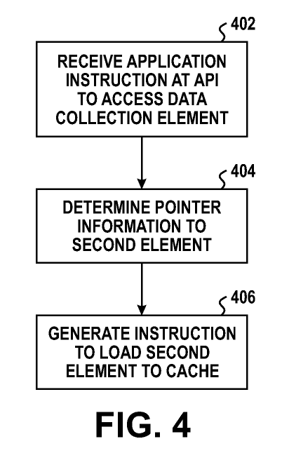

FIG. 4 illustrates a flow diagram of a particular embodiment of a method of accessing a data collection in accordance with one embodiment of the present disclosure. At block 402, the API 104 receives an application instruction from application 102 to access element 220 of data collection 201 (FIG. 2). In response, at block 404 the API 104 determines the pointer information 221 associated with element 220. At block 406, the API 104 automatically generates an instruction to load the element indicated by pointer information 221 (i.e. element 222) to the cache 109.

Other embodiments, uses, and advantages of the disclosure will be apparent to those skilled in the art from consideration of the specification and practice of the disclosure disclosed herein. It will further be appreciated that, although some circuit elements and modules are depicted and described as connected to other circuit elements, the illustrated elements may also be coupled via additional circuit elements, such as resistors, capacitors, transistors, and the like. The specification and drawings should be considered exemplary only, and the scope of the disclosure is accordingly intended to be limited only by the following claims and equivalents thereof.

What is claimed is:

1. A method, comprising:
receiving a first instruction from an application at an application program interface (API) at a data processing device, the first instruction comprising a request to access a first element of a first data collection stored at a memory module, the first element associated with first pointer information indicative of a second element of the first data collection;
in response to receiving the first instruction, automatically generating a second instruction; and
in response to the second instruction, loading the second element of the first data collection from the memory module to a cache.

2. The method of claim 1, wherein the first element and the second element are stored at non-contiguous locations of the memory module.

3. The method of claim 1, wherein the first instruction comprises a request to access second pointer information indicative of a memory location of the first element.

4. The method of claim 3, further comprising:
in response to receiving the first instruction, automatically generating a third instruction; and
in response to receiving the third instruction, loading the first element of the first data collection from the memory module to the cache.

5. The method of claim 1, wherein the first element is associated with second pointer information indicative of a third element of the first data collection, and further comprising:
in response to receiving the first instruction, automatically generating a third instruction; and
in response to the third instruction, loading the third element of the first data collection from the memory module to the cache.

6. The method of claim 1, wherein the first data collection comprises a linked list.

7. The method of claim 1, wherein the first data collection comprises a hash table.

8. The method of claim 1, wherein the first data collection comprises a tree structure.

9. The method of claim 1, wherein the first data collection comprises a doubly-linked list.

10. The method of claim 1, wherein the first data collection comprises a tree structure.

11. The method of claim 1, wherein generating the second instruction comprises:
generating the second instruction based on a wrapper library; and
providing the first instruction and the second instruction to a collection library;
generating a first load instruction based on the first instruction and the collection library; and
generating a second load instruction based on the second instruction and the collection library.

12. A computer readable medium tangibly embodying a set of instructions to manipulate a processor, the set of instructions comprising instructions to:
receive a first instruction from an application at an application program interface (API) at a data processing device, the first instruction comprising a request to access a first element of a first data collection stored at a memory module, the first element associated with first pointer information indicative of a second element of the first data collection;
in response to receiving the first instruction, automatically generate a second instruction; and
in response to the second instruction, load the second element of the first data collection from the memory module to a cache.

13. The computer readable medium of claim 12, wherein the first element and the second element are stored at non-contiguous locations of the memory module.

14. The computer readable medium of claim 12, wherein the first data collection is stored at a memory, and where a number of memory locations of the memory between the first element and the second element is different than a number of memory locations between the second element and a third element of the first data collection.

15. The computer readable medium of claim 12, wherein the first instruction comprises a request to access second pointer information indicative of a memory location of the first element.

16. The computer readable medium of claim 15, wherein the set of instructions further comprises instructions to:
in response to receiving the first instruction, automatically generate a third instruction; and
in response to receiving the third instruction, load the first element of the first data collection from the memory module to the cache.

17. The computer readable medium of claim 12, wherein the first element is associated with second pointer information indicative of a third element of the first data collection, and wherein the set of instructions further comprises instructions to:
in response to receiving the first instruction, automatically generate a third instruction; and
in response to the third instruction, load the third element of the first data collection from the memory module to the cache.

18. The computer readable medium of claim 12, wherein the first data collection comprises a linked list.

19. The computer readable medium of claim 12, wherein the first data collection comprises a hash table.

20. The computer readable medium of claim 12, wherein the first data collection comprises a tree structure.
